(19) United States
(12) Patent Application Publication
(10) Pub. No.: US 2016/0189017 A1
(43) Pub. Date: Jun. 30, 2016

(54) CONTAINER WITH A DATA MATRIX DISPOSED THEREON

(71) Applicant: Owens-Brockway Glass Container Inc., Perrysburg, OH (US)

(72) Inventors: Jessica R. Bryant, Toledo, OH (US); Roger P. Smith, Perrysburg, OH (US)

(21) Appl. No.: 15/061,317

(22) Filed: Mar. 4, 2016

Related U.S. Application Data
(63) Continuation of application No. 13/952,975, filed on Jul. 29, 2013.

(51) Int. Cl. G06K 19/06

(52) U.S. Cl. CPC G06K 19/06037

(57) ABSTRACT

An article, for example, a container, having an outer surface, at least a portion of which is curved, and a data matrix disposed on the curved portion of the outer surface that is optically-readable to provide information associated with the article. The data matrix comprises a plurality of optically-readable elements, one or more of which has a different dimension in a direction of curvature of the outer surface than one or more other of the elements so that the plurality of elements appear to have an expected size and shape when optically viewed in a plane perpendicular to a radial line extending from the surface.

The present disclosure is directed to articles, for example, containers, having optically-readable markings disposed thereon and, more particularly, to articles having optically-readable data matrices disposed thereon.

### BACKGROUND AND SUMMARY OF THE DISCLOSURE

Containers often include body and a neck finish extending axially from the body to accept a closure. The body may, in turn, include a base, a sidewall extending axially away from the base, and a shoulder between the sidewall and the neck finish. The body further may include neck extending between the shoulder of the body and the neck finish. In certain instances, one or more portions of the body of the container may have a marking, for example, a data matrix, disposed therein or thereon. The marking is configured such that when it is read and interpreted by an appropriately configured optical sensor, certain information relating to, for example, the container and/or the contents thereof, may be obtained.

A general object of the present disclosure, in accordance with one aspect of the disclosure, is to provide a container having a curved surface with a data matrix disposed thereon, wherein the data matrix is both readable and interpretable by, for example, an appropriately configured optical sensor.

The present disclosure embodies a number of aspects that can be implemented separately from, or in combination with, each other.

An article, in accordance with one aspect of the disclosure, includes an outer surface, at least a portion of which is curved, and a data matrix disposed on the curved portion optically-readable to provide information associated with the article. The data matrix comprises a plurality of optically-readable elements, one or more of which has a different dimension in a direction of curvature of the outer surface than one or more other of the elements so that the plurality of elements appear to have an expected size and shape when optically viewed in plane perpendicular to a radial line extending from the surface.

In accordance with another aspect of the disclosure, there is provided a container having an outer surface, at least a portion of which is curved, and a dot matrix disposed on the curved portion optically-readable to provide information associated with the container. The dot matrix comprises a plurality of optically-readable dots, one or more of which have a different horizontal radius than one or more other of the dots so that the dots appear to have an expected size and shape when optically viewed in a plane perpendicular to a radial line extending from the surface.

In accordance with a further aspect of the disclosure, there is provided a method of providing an optically-readable data matrix on a curved surface of an article for reading by an optical sensor having a sensor plane that is perpendicular to a radial line extending from the curved surface. The method includes the step of defining one or more of the dots to have at least one dimension that is different than that of one or other of the dots such that, when viewed in the sensor plane, the dots appear to have an expected size and shape.

### BRIEF DESCRIPTION OF THE DRAWINGS

The disclosure, together with additional objects, features, advantages and aspects thereof, will be best understood from the following description, the appended claims, and the accompanying drawings, in which:

FIG. 1 is an elevation view of a container in accordance with an illustrative embodiment of the present disclosure;

FIG. 2A is a fragmentary view of a portion of the container depicted in FIG. 1 illustrating an example of a data matrix in the form of a dot matrix disposed on an outer surface of the container;

FIG. 2B depicts an alternate embodiment of the dot matrix illustrated in FIG. 2A;

FIG. 3 is a flow chart depicting an illustrative method of providing an optically-readable data matrix on a curved surface of an article;

FIG. 4A is fragmentary sectional top view of the container of FIG. 1 illustrating an exemplary arrangement of a plurality of dots of a dot matrix disposed on a curved outer surface of the container;

FIGS. 4B and 4C depict illustrations of triangles formed by various dimensions and angles depicted in FIG. 4A;

FIG. 5A is another fragmentary sectional top view of the container of FIG. 1 illustrating a single dot of a dot matrix disposed on a curved outer surface of the container;

FIG. 5B is an enlarged view of a portion of the fragmentary sectional top view depicted in FIG. 5A; and

FIG. 5C depicts an illustration of a triangle formed by various dimensions and angles depicted in FIG. 5B.

### DETAILED DESCRIPTION

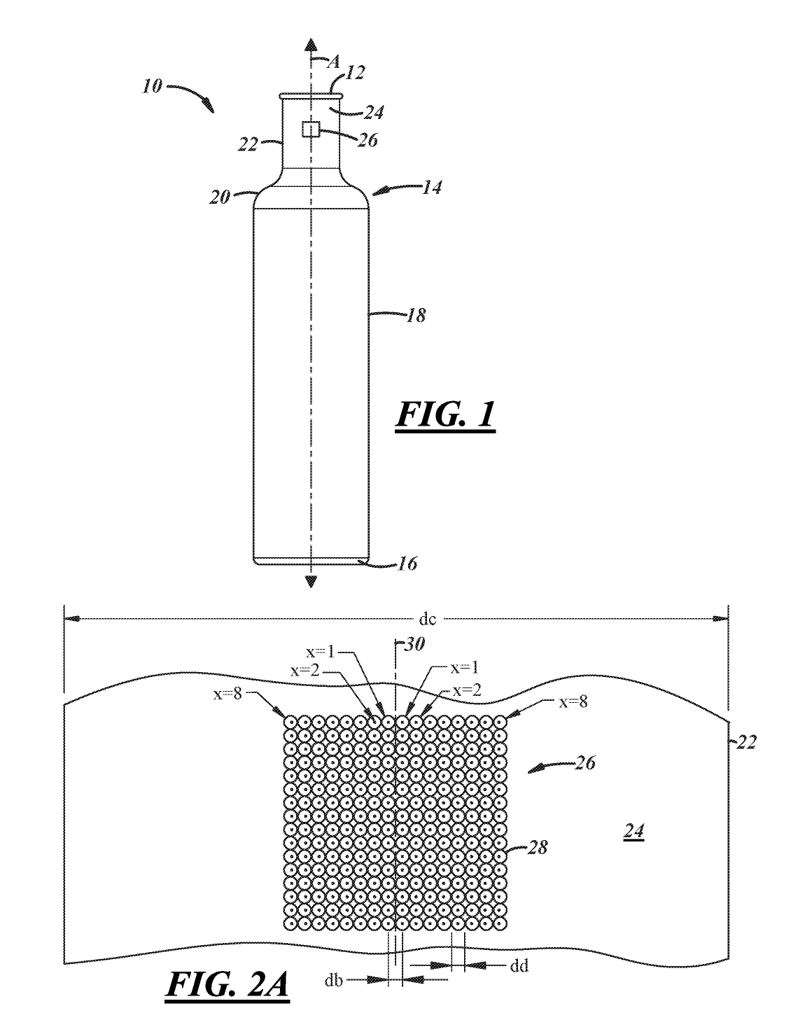

FIG. 1 depicts an illustrative article, for example, a container 10 including a longitudinal axis A, a neck finish 12, and a body 14. Other articles may include, for instance, dishware, glassware, lamps, sports equipment (e.g., baseball bats, lacrosse sticks, billiard cues, etc.), health and beauty products (e.g., perfume containers, lip stick tubes, lip balm tubes, mascara tubes, and/or other cosmetics products), medical supplies and equipment (e.g., syringes, vials, catheters, etc.) to cite a few possibilities. The body 14 may, in turn, include a base 16, a sidewall 18 extending axially away from the base 16 relative to axis A, and a shoulder 20 extending between the sidewall 18 and the neck finish 12. In the illustrative embodiment, the body 14 further includes a neck 22 extending axially between the shoulder 20 and the neck finish 12. While the body 14 is depicted in FIG. 1 as including each of the base 16, sidewall 18, shoulder 20, and neck 22, it will be appreciated that containers having fewer than all of these portions or elements remain within the scope of the present disclosure. The container 10 may be used to package food and beverage products, for example and without limitation, beer, soda, water, juice, pickles, baby food, salsa, peppers, spaghetti sauces, and jams. The container 10 also may be used to package products other than food and beverage products, including, but not limited to, liquids, gels, powders, particles, and the like. Further, the container 10 may be composed of glass, plastic, or any other material for containing, for example, food and beverage products.

In any instance, the container 10 includes an outer surface 24, at least a portion of which is curved in at least one direction, for instance, cylindrical or at a circular cross section perpendicular to axis A, elliptical, etc. The outer surface 24 may comprise an outer surface of, for example, any one of the sidewall 18, shoulder 20, and neck 22 of the container body 14. For purposes of illustration and clarity only, the description below will be with respect to an embodiment wherein the outer surface 24 comprises the outer surface of the neck 22. It will be appreciated, however, that the present disclosure is not meant to be so limited; rather in other embodiments, the outer surface 24 may comprise the outer surface of a portion or element of the container body 14 other than the neck 22.

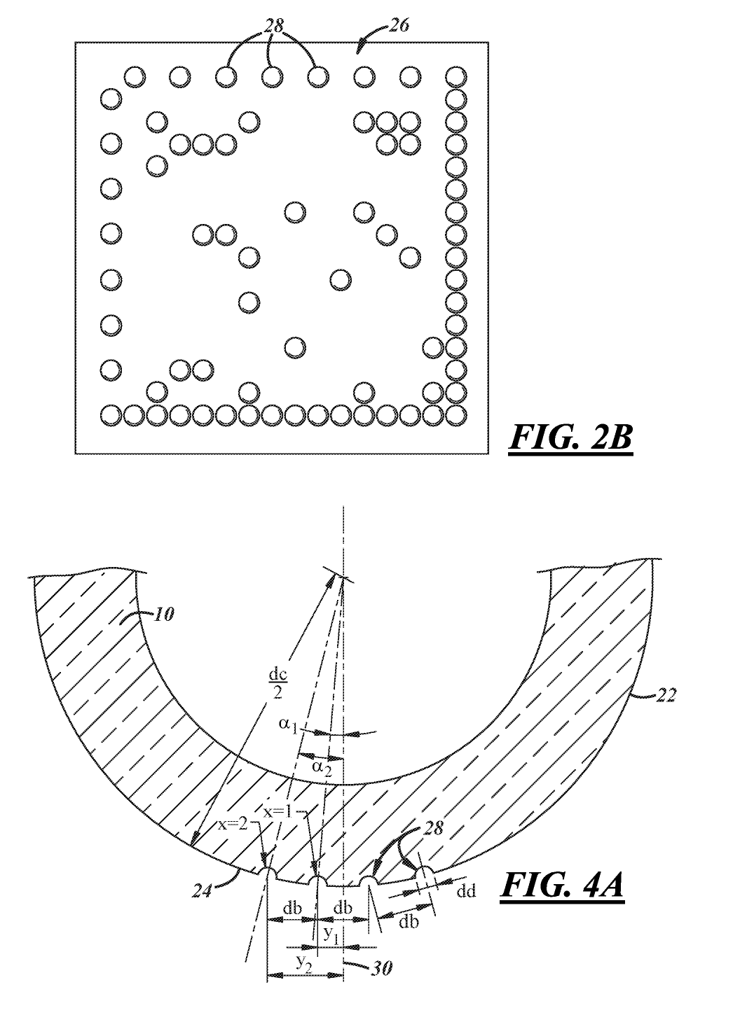

The container 10 further includes a data matrix 26 disposed on the curved portion of the outer surface 24 that is optically-readable to provide information associated with the container 10, for example, information about the container itself and/or the contents thereof. The data matrix 26 may comprise any identifying marking that includes one or more optically-readable elements or combination of elements (e.g., dots, letters, numbers, symbols, graphics, or other indicia) arranged in a particular manner. In the illustrative embodiment depicted in FIGS. 1, 2A, and 2B, the data matrix 26 comprises a dot matrix (i.e., “dot matrix 26”) that includes a plurality of optically-readable dots 28 arranged in a predetermined pattern (e.g., columns and rows). While the number and arrangement of dots 28 in the dot matrix 26 may differ depending on the particular application or implementation, in the embodiment illustrated in FIG. 2A, the dot matrix 26 is comprised of sixteen (16) rows of sixteen (16) dots (or a 16×16 matrix); though the present disclosure is not limited to such an arrangement. For example, in an embodiment such as that illustrated in FIG. 2B, the matrix 26 may have the general form of that illustrated in FIG. 2A but may not include every single dot. In other words the pattern of the dots 28 of the matrix 26 may be such that some of the rows and/or columns of the matrix may have less than sixteen (16) dots therein such that both the presence and absence of dots at certain locations contribute to the formation and composition of the pattern. Similarly, in other embodiments, the matrix 26 may be smaller or larger than a 16×16 matrix such that it may have fewer or more rows or columns than the matrices illustrated in FIGS. 2A and 2B, and it may have an equal or unequal number of rows and columns (e.g., a 16×32 matrix). In any event, in an embodiment, the dots 28 of the dot matrix 26 comprise a plurality of embossements or debossments integrally formed on the container 10 and in or on the outer surface 24 thereof, in particular. For purposes of illustration and clarity only, the description below will be with respect to an embodiment wherein the data matrix 26 comprises a dot matrix. It will be appreciated, however, that the present disclosure is not meant to be so limited; rather in other embodiments, the data matrix 26 may comprise a matrix that includes any number of optically-readable elements or combination(s) of elements in addition to or instead of dots.

In the embodiment illustrated in FIG. 2A, the dot matrix 26 includes a centerline 30 that, in an embodiment, is parallel to axis A of the container 10. The centerline 30 may additionally or alternatively be parallel to the axis of curvature of the curved portion of the outer surface 24. In any event, each dot 28 in the dot matrix 26, and the center-point thereof, in particular, is located a respective distance from the centerline 30. The particular location for each dot 28 relative to the centerline 30 may be determined in the manner described in greater detail below. Ideally, all of the dots 28 would be evenly or uniformly spaced apart throughout the matrix 26 and have the same size and shape. However, because the dot matrix 26 is disposed on a curved surface (i.e., on the curved portion of the outer surface 24), one or more of the dots 28 may have a shape and/or size that is different than one or more of the other dots 28 in the dot matrix 26 in order to allow the dot matrix 26 as a whole to be read by an optical sensor. More particularly, when a dot matrix is disposed on a curved surface, one or more of the dots may appear distorted due to the curvature of the surface when read from a plane that is normal or perpendicular to a radial line extending radially from the container axis A and through the curved surface (e.g., in an embodiment, normal to the matrix centerline 30) by an optical sensor (e.g., a smart phone or other suitable optical reading, sensing, or scanning device). For instance, in an example wherein the dots of the dot matrix are circles and the surface curves in a horizontal direction, certain of the dots may appear to be compressed or “squished” in a horizontal direction, while other dimensions of those dots in directions other than the direction of curvature (e.g., vertical diameter) may not be affected, such that the affected dots may appear to the optical sensor as ellipses rather than circles. In other words, the horizontal diameter of those dots appears to be less or smaller than it actually is.

In order to compensate for this effect, certain of the dots 28 of the dot matrix 26 may be purposefully “distorted” relative to a predetermined dot size, shape, and/or location such that when viewed from a single plane that is parallel to, for example, the centerline 30 of the matrix 26, and/or in certain embodiments, tangential to a portion of the outer surface 24 of the container 10, for example, that corresponding to the centerline 30, all of the dots 28 appear to be of an expected or anticipated size and shape and in an expected or anticipated location (e.g., expected center-to-center spacing between adjacent dots). In other words, the dots 28 of the dot matrix 26 are designed and arranged in such a manner that they each appear to have the size, shape, and location or spacing (dot-to-dot spacing) as would be expected if all of the dots 28 were disposed in a flat plane—not on a curved surface—and viewed or read by an optical sensor in a plane parallel to that flat plane. More particularly, in an embodiment, some of the dots 28 may have at least one dimension in a direction of curvature of the curved surface, for example, a radius or diameter, that is greater than that of one or more other of the dots 28 so that all of the dots 28 of the matrix 26 appear to have an expected or anticipated shape (e.g., circular) and size (e.g., diameter) when viewed in a plane that is normal or perpendicular to a radial line extending radially from the container axis A and through the surface 24, and which, in an embodiment, corresponds to the centerline 30 of the matrix 26, though in other embodiments it need not correspond to the centerline 30. For purposes of this disclosure, the terms “perpendicular” and “normal” are intended to include instances wherein the viewing plane is exactly normal or perpendicular to the radial line, and those wherein the viewing plane is not exactly normal or perpendicular but is still suitable for accurately reading the matrix due to, for example, the tolerances of the reader being used and other operating conditions.

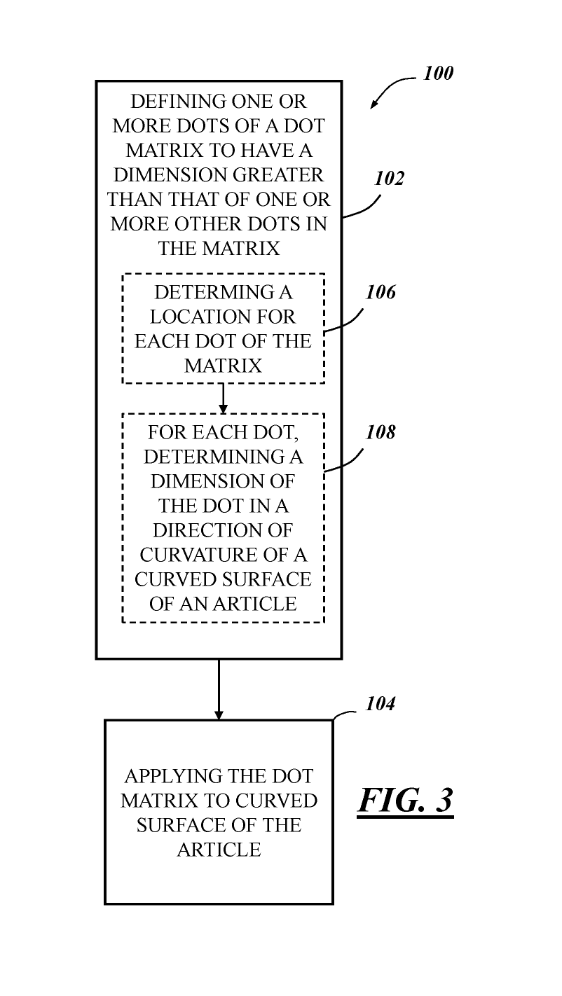

The process or method of “distorting” the dots 28 of the dot matrix 26 to provide an optically-readable dot matrix on a curved surface may be carried out in a number of ways and/or using a number of techniques. One such technique is that illustrated in FIG. 3 and referred to as “method 100.” In the illustrative embodiment, and in general terms, method 100 includes a step 102 of defining or establishing one or more of the dots 28 of the dot matrix 26 to have at least one dimension in a direction of curvature of the surface 24 on or in which the matrix 26 is disposed that is different than that of one or more other of the dots 28, and a step 104 of applying the matrix 26 to the curved surface 24 of the container 10.

In an embodiment, the defining step 102 may include a number of substeps. For example, in the embodiment illustrated in FIG. 3, step 102 may include a first substep 106 of determining a respective location for each dot 28 relative to the centerline 30 of the matrix 26. The dot locations may be determined in one or more ways. In one embodiment, and with reference to FIG. 2A, for each dot 28 in a row of dots, the particular position of the dot 28 within the row relative to the centerline 30 may be used with certain known parameters to calculate a distance from the centerline 30 at which the center-point of the dot 28 is to be placed. In an embodiment, these parameters may include, for example, an expected or anticipated distance between the center-points of adjacent dots (“db”) and the diameter of the portion of the container 10 in or on which the matrix 26 is to be disposed (“dc”), to cite a few possible parameters).

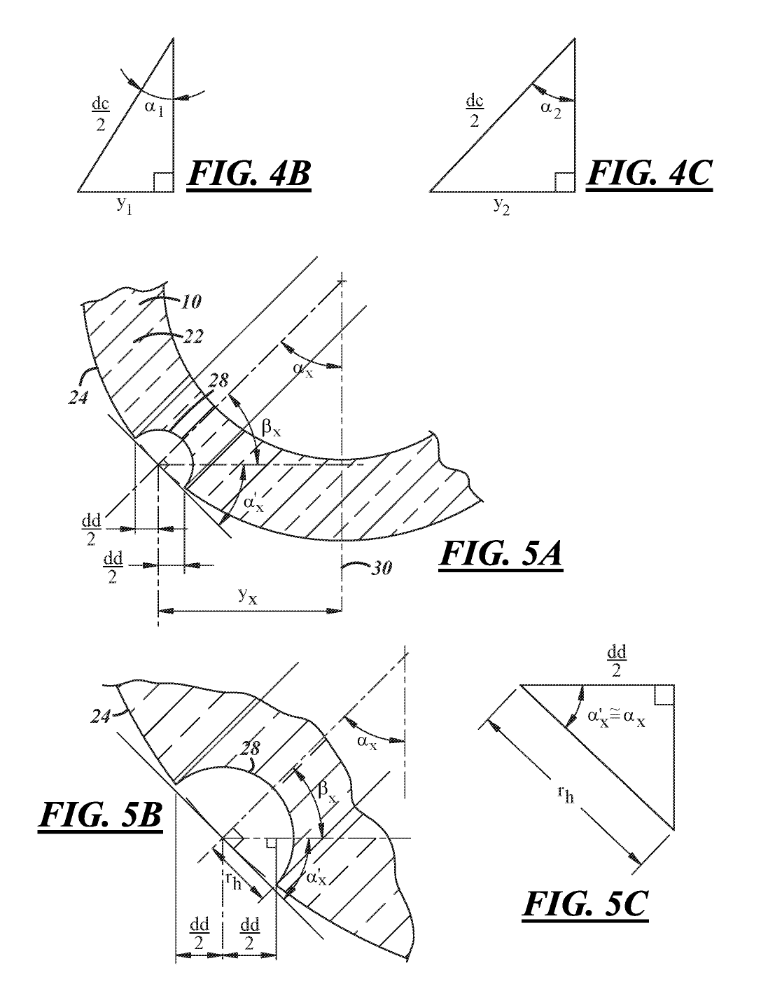

More particularly, and with reference to FIGS. 2A and 4A-4C, each dot 28 has a corresponding position (x) associated therewith relative to the matrix centerline 30. For example, and with particular reference to FIG. 2A, for a given row of dots, the first dots 28 immediately to the left and right of the centerline 30 each have a position of x=1; the second dots 28 on each side of the centerline 30 and adjacent to the respective first dots each have a position of x=2; and so on and so forth such that the eighth dots on each side of the centerline 30 (i.e., the dots furthest away from the centerline 30) each have a position of x=8. In an embodiment, for a particular dot 28, the particular position of the dot (e.g., x=1, 2, 3 . . . 8) and the known parameter db (i.e., the expected or anticipated distance between the center-points of adjacent dots) can be used to determine a distance (y) from the centerline 30 at which the center-point of the dot 28 should be placed, and therefore, a location of the dot 28. For example, for the first dots 28 immediately to the left and right of the centerline 30 of the matrix 26 (i.e., x=1), it can be seen from FIGS. 4A and 4B that a distance (y₁) from the centerline 30 to the center-point of the dot 28 is y₁=(½) db. For the dots in the second position to the right and left of the centerline 30 (i.e., x=2), it can be seen from FIGS. 4A and 4C that a distance (y₂) from the centerline 30 to the center-point of the dot 28 is y₂=(3/2) db. From the foregoing, it can be seen that the distances y₁ and y₂, as well as the distance between any dot 28 and the centerline 30 may be determined using equation (1):

$${y}_{x} = ( \frac{2 x - 1}{2} ) db ; \qquad ( 1 )$$

wherein, as described above, “x” is the position of the dot of interest within its corresponding row relative to the centerline 30, and “db” is the expected or anticipated distance between the center-points of adjacent dots.

For purposes of illustration only, and to demonstrate several illustrative dot location calculations, assume that the dot matrix 26 is that illustrated in FIG. 2A, and that db=0.020 in. In this scenario, and using equation (1), a location for the first dots 28 immediately to the left and right of the centerline of the matrix (i.e., x=1) may be calculated to be y₁=0.01 in., meaning that those dots 28 would be placed 0.01 in. to the left and right of the centerline 30, respectively. Using the same equation and parameter values set forth above, a location for the dots 28 in the second position to the left and right of the centerline 30 (i.e., x=2) may be calculated to be y₂=0.03 in., meaning that those dots 28 would be placed 0.03 in. to the left and right of the centerline 30, respectively.

With respect to FIGS. 4B and 4C, because the distance (y) of each dot 28 from the centerline 30 is known or may be derived from equation (1) above, and because the diameter (dc) of the portion of the container at which the matrix 26 is to be disposed is also known, it is possible to determine the respective angles (αₓ) between the center-point of each dot 28 and the centerline 30. More particularly, with respect to the dots 28 in the first and second positions (i.e., x=1 and x=2), the respective angles between the center-points of those dots 28 and the matrix centerline 30 (i.e., angles “α₁” and “α₂”) can be determined from the following equations (2)-(4):

$$\begin{matrix}sin {∝}_{1} = \frac{{y}_{1}}{( \frac{dc}{2} )} \to sin {∝}_{1} = \frac{\frac{1}{2} db}{( \frac{dc}{2} )} ; and & ( 2 ) \\ sin {∝}_{2} = \frac{{y}_{2}}{( \frac{dc}{2} )} \to sin {∝}_{2} = \frac{\frac{3}{2} db}{( \frac{dc}{2} )} ; and therefore \text{:} & ( 3 ) \\ sin {∝}_{x} = \frac{( \frac{2 x - 1}{2} ) db}{( \frac{dc}{2} )} \to {∝}_{x} = {sin}^{- 1} [ \frac{( \frac{2 x - 1}{2} ) db}{( \frac{dc}{2} )} ] ; & ( 4 )\end{matrix}$$

wherein, as described above, “x” is the position of the dot of interest, “db” is the predetermined expected or anticipated distance between the center-points of adjacent dots, and “dc” is the diameter of the portion of the container 10 in or on which the matrix 26 is to be disposed. From the foregoing, it will be appreciated that the angle between the center-point of any dot 28 of the matrix 26 and the centerline 30 thereof may be determined using equation (4).

For purposes of illustration only, and to demonstrate several exemplary calculations, assume that the dot matrix 26 is that illustrated in FIG. 2A, and that db=0.020 in. and dc=1.2 in. In this scenario, and using equation (4), the angle between the center-point of the first dots 28 immediately to the left and right of the centerline of the matrix (i.e., x=1) and the centerline 30 may be calculated to be α₁=0.954°. Using the same equation and parameter values set forth above, the angle between the center-point of the dots 28 in the second position to the left and right of the centerline 30 (i.e., x=2) and the centerline 30 may be calculated to be α₂=2.865°. The angle between the center-point of a dot 28 and the centerline 30 of the matrix 26 may be used for a number of purposes, including, for example, to determine the location of the dot relative to the centerline (e.g., the distance from the centerline 30 at which the center-point of the dot 28 should be placed) and/or that or those purposes described below.

In addition to substep 106 described above, in an embodiment, the defining step 102 further may comprise another substep 108 of determining, for each dot 28, value(s) or magnitude(s) of one or more dimensions of the dot that is/are required to achieve a projected dot of the appropriate size and shape when the matrix 26 is viewed from a plane that is parallel to the matrix centerline 30, and/or in at least certain embodiments, tangential to a portion of the outer surface 24 of the container 10, for example, that corresponding to the centerline 30 (i.e., each of the dots appears as a perfect or near perfect expected geometric shape (e.g., circle) of an expected or anticipated size (e.g., diameter)). In an embodiment, and for a given dot 28, substep 108 includes determining a value for a dimension of the dot 28 in a direction of curvature of the outer surface 24 of the container on or in which the dot matrix 26 will be disposed. One example of such a dimension, though certainly not the only one, is a radius of the dot 28, for example, the horizontal radius of the dot 28.

In an embodiment wherein the horizontal radius is the dimension for which a value is to be determined in sub step 108, it may be determined in one or more ways. For instance, and with reference to FIGS. 5A-5C, because the distance (yₓ) and the angle (αₓ) between the center-point of a given dot and the centerline 30 of the matrix 26, are known or can be determined from respective equations (1) and (4) above, the complementary angle (βₓ) of angle αₓ can be determined (i.e., βₓ=90−αₓ). Further, since angle βₓ can be determined, an angle adjacent thereto, angle α′ₓ, can also be determined (i.e., α′ₓ=90−βₓ). It will be appreciated that α′ₓ and αₓ are very close if not equal in magnitude, and therefore, for the purposes below, an assumption that α′ₓ≅αₓ can be made.

Based on this assumption, in one embodiment, the horizontal radius of a particular dot 28 may be determined based on, for example, the particular position of the dot 28 relative to the centerline 30 of the matrix 26 and certain other known parameters, including, for example, one or more of those described above (e.g., the expected or anticipated distance between the center-points of adjacent dots (db) and the diameter of the portion of the container 10 in or on which the matrix 26 is to be disposed (dc)), and/or additional parameters, for example, an expected or anticipated dimension of the dots, for example and without limitation, the expected or anticipated diameter of the dots 28 (“dd”). Using this information, and with continued reference to FIGS. 5A-5C, a horizontal radius (rₕ) for each dot 28 may be determined from equation (5):

$$cos ( {α}_{x} ) = \frac{( \frac{dd}{2} )}{{r}_{h}} \to {r}_{h} = \frac{( \frac{dd}{2} )}{cos ( {α}_{x} )} . \qquad ( 5 )$$

Since it is known from equation (4) above that

$${∝}_{x} = {sin}^{- 1} [ \frac{( \frac{2 x - 1}{2} ) db}{( \frac{dc}{2} )} ] ,$$

equation (5) can be expressed as equation (6):

$${r}_{h} = \frac{( \frac{dd}{2} )}{cos ( {sin}^{- 1} [ \frac{( \frac{2 X - 1}{2} ) d b}{( \frac{d c}{2} )} ] )} ; \qquad ( 6 )$$

wherein, as described above, “α” is the angle between the center-point of the dot of interest and the matrix centerline 30, “x” is the position of the dot of interest relative to the centerline 30, “db” is the predetermined expected or anticipated distance between the center-points of adjacent dots, “dc” is the diameter of the portion of the container at which the matrix is to disposed, and “dd” is a predetermined expected or anticipated dot diameter.

For purposes of illustration, and to demonstrate several exemplary horizontal radius calculations, assume that the dot matrix 26 is that illustrated in FIG. 2A, and that db=0.020 in., dc=1.2 in., and dd=0.019 in. In this scenario, and using either of equations (5) or (6), the horizontal radius of the first dots 28 immediately to the left and right of the centerline of the matrix (i.e., x=1) may be calculated to be rₕ=0.0095 in. Using the same equation and parameter values set forth above, the horizontal radius of the dots in the eighth position to the left and right of the centerline 30 (i.e., x=8) may be calculated to be rₕ=0.0098 in. Once the radius of a dot 28 has been determined, it may then be used to calculate or determine a diameter of the dot 28 (i.e., d=2r)

It will be appreciated in view of the above that for a given row of dots, the horizontal radius of the dots 28 increases as the dots 28 get further away from the centerline 30. Accordingly, using the techniques described above, and depending on the particular size and constitution of the matrix (i.e., the number of rows and dots), one or more of the dots 28 of the matrix 26 will have a different horizontal radius than one or more other of the dots 28. It will be further appreciated that in an embodiment, the dots 28 on one side of the centerline 30 will be a mirror image of the dots 28 on the other side of the centerline 30, though in other embodiments they need not be. More specifically, and with reference to FIG. 2A, for the first (top) row of dots, the dot 28 in position x=1 to the left of the centerline 30 will have the same size, shape, and distance from the centerline 30 as the dot 28 in position x=1 to the right of the centerline 30; the dot 28 in position x=2 to the left of the centerline 30 will have the same size, shape, and distance from the centerline 30 as the dot 28 in position x=2 to the right of the centerline 30; and so on and so forth.

In any event, using the techniques described above, a location and a dimension in the direction of curvature of the outer surface 24 for each dot 28 of the dot matrix 26 may be determined and used to create or establish the dot matrix 26. Once created, the dot matrix 26 may be applied (in step 104) to the curved outer surface 24 of the container 10 using known techniques. These techniques may include, for example and without limitation: laser etching the matrix 26 onto/into the surface 24; silk screen, ink-jet, and/or three-dimensional printing the matrix 26 onto the surface 24; affixing pre-printed labels containing the matrix 26 onto the surface 24; applying the matrix using applied ceramic labeling (ACL); stamping the matrix onto/into the surface 24 (e.g., as part of the container manufacturing process); and/or utilizing embossing/debossing techniques to cite a few possibilities. Because the size, shape, and/or location (spacing) of the dots have been sufficiently “distorted” prior to the matrix 26 being applied to the container surface 24, each of the dots 28 will appear to have an expected or anticipated shape (e.g., circular) and an expected or close to expected size (e.g., diameter), and be spaced from adjacent dots 28 in the matrix 26 by an expected or close to expected distance, when the matrix is optically viewed in a plane parallel to the centerline 30 (and/or in certain embodiments, tangential to a portion of the outer surface 24 of container 10, for example, that corresponding to the centerline 30), which is also perpendicular to a radius from the surface 24, even though each and every dot may not have the expected or anticipated size and/shape (e.g., some dots may be circular while others may be elliptical).

It will be appreciated that while the description above has been with respect to an embodiment wherein one or more of the dots 28 of the dot matrix 26 have been defined or established to have a horizontal radius in the direction of curvature of the surface 24 that is different than that of one or more other of the dots 28, the present disclosure is not meant to be limited to such an embodiment. Rather, those having ordinary skill in the art will appreciate that in other embodiments, one or more dots 28 of the dot matrix 26 may be defined or established to have dimensions in addition to or instead of the horizontal radius that are different than that of one or more other of the dots 28 in the matrix 26. For example, in an embodiment wherein the outer surface 24 of the container is curved in a different or additional direction from that described above (e.g., the shoulder 20 may be curved both horizontally and vertically), one or more of the dots 28 of the matrix 26 may be defined or established (e.g., “distorted”) to take into account the corresponding curvature of the surface 24 in the same or similar manner as that described above. Similarly, while the description above is primarily directed to an embodiment wherein the portion of the container 10 at which the matrix 26 is disposed has at least a substantially constant diameter, the present disclosure is not meant to be so limited. Rather, those having ordinary skill in the art will appreciated that in other embodiments, dots 28 located at portions of the container 10 having different diameters may be defined or established to take into account the container diameters corresponding thereto. For example, in an embodiment wherein the neck 22 of the container 10 is conical or tapered, each row of dots 28 may be evaluated or defined utilizing the equations described above with the particular container diameters corresponding thereto. Accordingly, in such an embodiment, dots 28 that are in different rows but that are vertically aligned with each other may not have the exact same size, shape, and/or relative location with respect to the centerline 30 of the matrix 26.

While the description above has been with respect to a container having a data matrix disposed on a curved surface thereof, the present disclosure is not meant to be so limited. Rather, it will be appreciated that the description above may find applicability with any number of articles or articles of manufacture having a curved surface and a data matrix disposed thereon. Accordingly, the present disclosure applies with equal weight to instances where an article other than a container has a curved surface and a data matrix disposed thereon.

There thus has been disclosed an article (e.g., container) having an optically-readable dot matrix disposed on a curved surface thereof that in at least one embodiment may be read by an optical sensor from a plane that is parallel to the centerline of the dot matrix (and/or in at least certain embodiments, tangential to a portion of the outer surface of the article, for example, that corresponding to the centerline of the matrix) that fully satisfies one or more of the objects and aims previously set forth. The disclosure has been presented in conjunction with several illustrative embodiments, and additional modifications and variations have been discussed. Other modifications and variations readily will suggest themselves to persons of ordinary skill in the art in view of the foregoing discussion. For example, the subject matter of each of the embodiments is hereby incorporated by reference into each of the other embodiments, for expedience. The disclosure is intended to embrace all such modifications and variations as fall within the spirit and broad scope of the appended claims.

1. An article having:
an outer surface, at least a portion of which is curved; and
a data matrix on said curved portion optically-readable to provide information associated with the article;
wherein said data matrix comprises a plurality of optically-readable elements that when read by an optical sensor provide said information associated with the article, and further wherein a dimension of said plurality of elements in a direction of curvature of said outer surface gets progressively larger the further away said elements are from a centerline of said matrix such that the dimension in the direction of curvature of a given element of said plurality of elements is greater than that of any other element of said plurality of elements that is closer to said centerline than said given element.

2. The article set forth in claim 1 wherein said data matrix comprises a plurality of embossments or debossments integrally formed on or in the surface of the article.

3. The article set forth in claim 1 wherein said data matrix comprises at least one row of elements, and further wherein said dimension of said elements in said row of elements gets progressively larger the further away said elements are from said centerline.

4. The article set forth in claim 1 wherein said data matrix comprises at least one row of elements, and further wherein said elements in said row of elements on each side of said centerline of said matrix are mirror images of each other with respect to the size and shape of said elements and the spacing between adjacent elements.

5. The article set forth in claim 1 wherein each element in said data matrix has a circular shape.

6. The article set forth in claim 1 wherein said plurality of elements have a size and shape optically-readable by said optical sensor in a plane perpendicular to a radial line extending from said surface.

7. The article set forth in claim 1 wherein when said plurality of elements is optically read in said plane that is perpendicular to said radial line extending from said surface and also parallel to said centerline, each element of said plurality of elements contained in the reading has the same size and shape as the other elements of said plurality of elements contained in the reading.

8. The article set forth in claim 1 wherein when said plurality of elements is optically read in said plane that is perpendicular to said radial line extending from said surface, each element of said plurality of elements contained in the reading has the same size as the other elements of said plurality of elements contained in the reading.

9. The article set forth in claim 1 wherein when said plurality of elements is optically read in said plane that is perpendicular to said radial line extending from said surface, each element of said plurality of elements contained in the reading has the same shape as the other elements of said plurality of elements contained in the reading.

10. The article set forth in claim 9 wherein said shape is a circular shape.

11. A method of providing an optically-readable data matrix on a curved surface of an article for reading by an optical sensor having a sensor plane that is perpendicular to a radial line extending from said curved surface, and wherein the data matrix comprises a plurality of optically-readable elements that when read by the optical sensor provide information associated with the article, the method including the steps of:
defining said elements of said matrix to have at least one dimension that gets progressively larger the further away said elements are from a centerline of said matrix such that the dimension in the direction of curvature of a given element of said plurality of elements is greater than that of any other element of said plurality of elements that is closer to said centerline than said given element; and
applying said data matrix to said curved surface of said article.

12. The method set forth in claim 11 further comprising the step of determining a location for each element of said matrix relative to said centerline of said matrix.

13. The method set forth in claim 12 wherein said determining step comprises calculating, for each of said elements, a respective distance from said centerline based on a predetermined distance between the center-points of adjacent elements.

14. The method set forth in claim 13 wherein the calculating step comprises calculating, for each of said elements, said respective distance (y) from said centerline of said matrix using the equation:
$${y}_{x} = ( \frac{2 x - 1}{2} ) d b ,$$
wherein “x” is the position of said element in said data matrix relative to said centerline of said matrix and “db” is a known predetermined distance between center-points of adjacent elements.

15. The method set forth in claim 11 wherein said defining step comprises determining, for each of said elements, a respective value for said at least one dimension thereof.

16. The method set forth in claim 15 wherein said determining step comprises calculating, for each of said elements, a respective value for said at least one dimension thereof.

17. The method set forth in claim 11 wherein each element in said data matrix has a circular shape.

18. The method set forth in claim 11 wherein said defining step comprises defining said at least one dimension of said elements such that said elements are optically-readable by said optical sensor in said sensor plane.

19. The method set forth in claim 11 wherein said defining step comprises defining said at least one dimension of said elements such that when said plurality of elements is optically read by said optical sensor in said sensor plane, each element of said plurality of elements contained in the reading has the same size as the other elements of said plurality of elements contained in the reading.

20. The method set forth in claim 11 wherein said defining step comprises defining said at least one dimension of said elements such that when said plurality of elements is optically read by said optical sensor in said sensor plane, each element of said plurality of elements contained in the reading has the same shape as the other elements of said plurality of elements contained in the reading.

21. The method set forth in claim 20 wherein said shape comprises a circular shape.

22. A container having:
an outer surface, at least a portion of which is curved; and
a dot matrix on said curved portion optically-readable to provide information associated with the container;
wherein said dot matrix comprises a plurality of optically-readable, circularly-shaped dots that when read by an optical sensor provide information associated with the article, and one or more of which have a different horizontal radius than one or more other of said dots so that said plurality of dots is optically-readable by the optical sensor in a plane perpendicular to a radial line extending from said surface.

23. The container set forth in claim 22 wherein said dot matrix comprises at least one row of dots, and further wherein said horizontal radius of said dots in said row of dots gets progressively larger the further away said dots are from a centerline of said matrix.

24. The container set forth in claim 22 wherein said dot matrix comprises at least one row of dots, and further wherein said dots in said row of dots on each side of a centerline of said matrix are mirror images of each other with respect to the size and shape of said dots and the spacing between adjacent dots.

25. The container set forth in claim 22 wherein the container has a neck portion and said dot matrix is disposed on said neck portion.

26. The container set forth in claim 22 wherein said dot matrix comprises a plurality of embossments or debossments integrally formed in or on said outer surface of the container.

27. The container set forth in claim 22 wherein when said plurality of dots is optically read in said plane that is perpendicular to said radial line extending from said surface and also parallel to a centerline of said matrix, each dot of said plurality of dots contained in the reading has the same size and shape as the other dots of said plurality of dots contained in the reading.

28. The container set forth in claim 22 wherein when said plurality of dots is optically read in said plane that is perpendicular to said radial line extending from said surface, each dot of said plurality of dots contained in the reading has the same size as the other dots of said plurality of dots contained in the reading.

29. The container set forth in claim 22 wherein when said plurality of dots is optically read in said plane that is perpendicular to said radial line extending from said surface, each dot of said plurality of dots contained in the reading has the same shape as the other dots of said plurality of dots contained in the reading.

30. The container set forth in claim 22 wherein said horizontal radii of said plurality of dots increases with distance from a centerline of said matrix.
